(19) United States
(12) Patent Application Publication
(10) Pub. No.: US 2026/0307442 A1
(43) Pub. Date: Oct. 8, 2026

(54) HOUSING

(71) Applicant: SUBARU CORPORATION, Tokyo (JP)

(72) Inventors: Satoru AKIYAMA, Tokyo (JP); Qiaoqin ZHOU, Tokyo (JP); Koichi UCHIKAWA, Tokyo (JP)

(73) Assignee: SUBARU CORPORATION, Tokyo (JP)

(21) Appl. No.: 19/341,152

(22) Filed: Sep. 26, 2025

(30) Foreign Application Priority Data
Oct. 8, 2024 (JP) 2024-176648

(51) Int. Cl. B60G 7/00; B60G 3/22

(52) U.S. Cl. CPC B60G 7/008; B60G 3/225; B60G 2200/144; B60G 2200/46; B60G 2204/148; B60G 2206/7102

(57) ABSTRACT

A housing for a high-mount double-wishbone suspension device includes a housing main body, a coupling arm, and a fixation mechanism. The housing main body supports an axle of a vehicle. The coupling arm is constituted by a separate member from the housing main body and has a distal end portion to which an upper arm is coupled. The fixation mechanism fixes the coupling arm to the housing. The fixation mechanism fixes the coupling arm to the housing main body in multiple fixation positions with different lengths from the housing main body to the distal end portion of the coupling arm.

### CROSS-REFERENCE TO RELATED APPLICATIONS

The present application claims priority from Japanese Patent Application No. 2024-176648 filed on Oct. 8, 2024, the entire contents of which are hereby incorporated by reference.

### BACKGROUND OF THE INVENTION

### Field of the Invention

The disclosure relates to a housing used for a high-mount double-wishbone suspension device.

### Description of Background Art

Japanese Unexamined Patent Application Publication No. 2004-291963 describes a double-wishbone suspension device. The entire contents of this publication are incorporated herein by reference.

### SUMMARY OF THE INVENTION

According to one aspect of the present invention, a housing for a high-mount double-wishbone suspension device includes a housing main body supports an axle of a vehicle, a coupling arm having a distal end portion to which an upper arm is coupled, and a fixation mechanism that fixes the coupling arm to the housing. The fixation mechanism fixes the coupling arm to the housing main body in fixation positions with different lengths from the housing main body to the distal end portion of the coupling arm.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a rear view of a high-mount double-wishbone suspension device set at a first vehicle height;

FIG. 2 is a rear view of a high-mount double-wishbone suspension device set at a second vehicle height;

FIG. 3 is an exploded rear view of a housing;

FIG. 4 is an exploded side view of the housing when viewed from the inner side in a vehicle width direction;

FIG. 5 is a rear view of the housing whose coupling arm is set at a first length;

FIG. 6 is a side view of the housing whose coupling arm is set at the first length, when viewed from the inner side in the vehicle width direction;

FIG. 7 is a rear view of the housing in which the inclination angle of the coupling arm of the first length has been changed;

FIG. 8 is an exploded side view of the housing when viewed from the inner side in the vehicle width direction;

FIG. 9 is a rear view of the housing whose coupling arm is set at a second length;

FIG. 10 is a side view of the housing whose coupling arm is set at the second length, when viewed from the inner side in the vehicle width direction; and

FIG. 11 is a rear view of the housing in which the inclination angle of the coupling arm of the second length has been changed.

### DETAILED DESCRIPTION OF THE EMBODIMENTS

Embodiments will now be described with reference to the accompanying drawings, wherein like reference numerals designate corresponding or identical elements throughout the various drawings.

In the following, factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis.

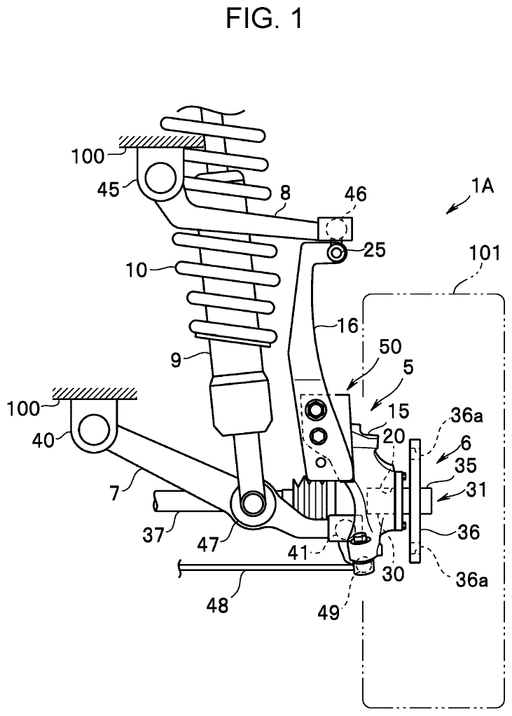

FIG. 1 is a rear view of a high-mount double-wishbone suspension device set at a first vehicle height.

A suspension device 1A illustrated in FIG. 1 is a high-mount double-wishbone suspension device. The suspension device 1A is applied to, for example, a vehicle set at the first vehicle height that is a standard vehicle height.

As illustrated in FIG. 1, the suspension device 1A includes a housing (knuckle) 5, a wheel hub unit 6, a lower arm 7, an upper arm 8, a hydraulic damper 9, and a suspension spring 10.

The housing 5 includes a housing main body 15 and a coupling arm 16.

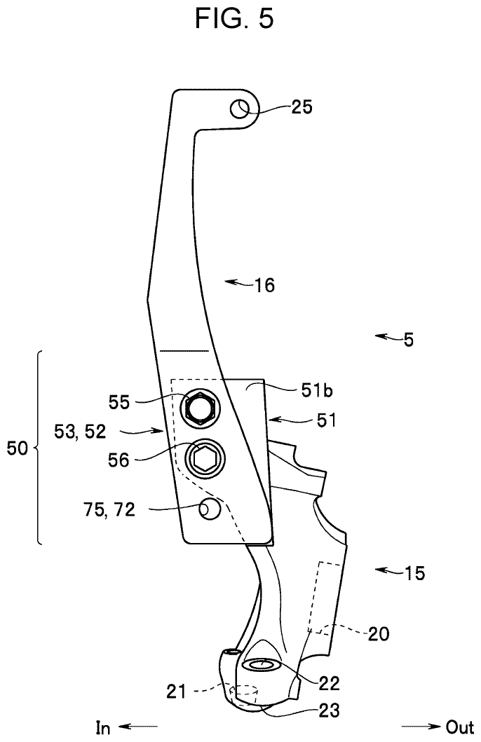

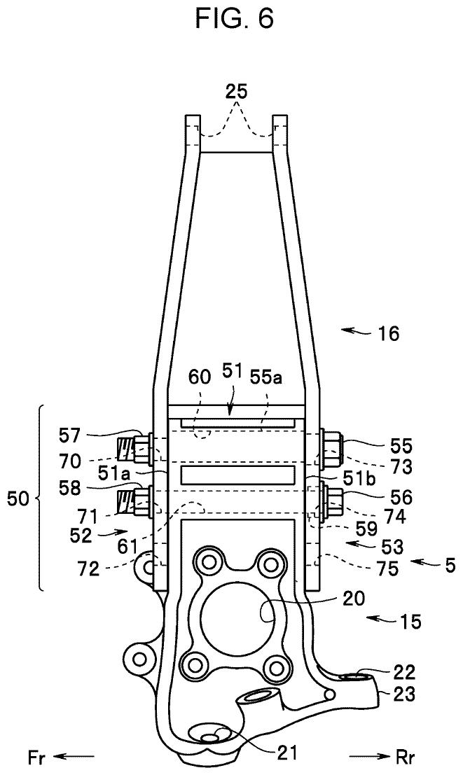

As illustrated in FIGS. 5 and 6, the housing main body 15 has a bearing insertion hole 20, a first ball-joint attachment hole 21, and a second ball-joint attachment hole 22.

The bearing insertion hole 20 is constituted by a cylindrical hole extending through the housing main body 15 in a vehicle width direction.

The first ball-joint attachment hole 21 is constituted by a hole extending through the housing main body 15 in an up-down direction at a lower end of the housing main body 15.

The second ball-joint attachment hole 22 is provided, for example, in a protrusion 23 protruding rearward from a lower portion of the housing main body 15. The second ball-joint attachment hole 22 is constituted by a hole extending through the protrusion 23 in the up-down direction.

The coupling arm 16 extends from an upper portion of the housing main body 15 and reaches a point above a tire 101. The coupling arm 16 has an attachment hole 25 in a distal end portion.

The wheel hub unit 6 includes a bearing 30 and a wheel hub 31.

The bearing 30 is fixed to the housing main body 15 while inserted into the bearing insertion hole 20.

The wheel hub 31 is rotatably supported by the housing main body 15 through the bearing 30. The wheel hub 31 includes a shaft-support hollow cylinder 35 and a flange 36.

The shaft-support hollow cylinder 35 has a substantially hollow cylindrical shape. The shaft-support hollow cylinder 35 is spline-coupled to a distal end portion of a drive shaft 37 that is an axle of a vehicle. Thus, the distal end portion of the drive shaft 37 is rotatably supported by the housing main body 15 through the wheel hub unit 6.

The flange 36 is provided on an outer periphery of the shaft-support hollow cylinder 35. The flange 36 has multiple bolt insertion holes 36a for coupling a brake disk and a wheel of the tire 101 by fastening.

A proximal end portion of the lower arm 7 is swingably supported relative to a vehicle body 100 through a bracket 40. In addition, a distal end portion of the lower arm 7 is coupled to the first ball-joint attachment hole 21 through a ball joint 41.

A proximal end portion of the upper arm 8 is swingably supported relative to the vehicle body 100 through a bracket 45. In addition, a distal end portion of the upper arm 8 is coupled to the attachment hole 25 of the coupling arm 16 through a ball joint 46.

An upper end portion of the hydraulic damper 9 is coupled to the vehicle body 100 with a strut mount therebetween, which is not illustrated. In addition, a lower end portion of the hydraulic damper 9 is coupled to a middle portion of the lower arm 7 through a rubber bush joint 47. The suspension spring 10 is held on an outer periphery of the hydraulic damper 9.

Note that a tie rod 48 extending from a steering mechanism, which is not illustrated, is coupled to the second ball-joint attachment hole 22 of the housing main body 15 through a ball joint 49.

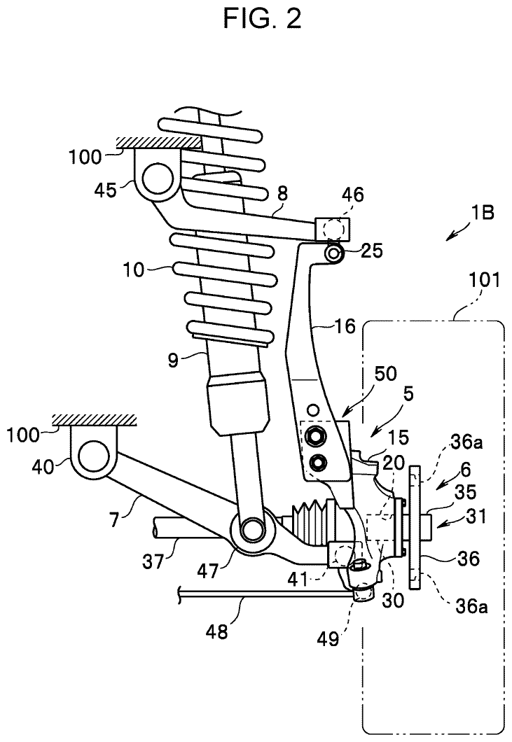

Now, when the high-mount double-wishbone suspension device configured as described above is applied to, for example, a vehicle of different vehicle height, the length of the coupling arm 16 extending from the housing main body 15 is to be changed. For example, FIG. 2 illustrates a suspension device 1B that is applied to an SUV set at a second vehicle height greater than the first vehicle height. In such a suspension device 1B, the length of the coupling arm 16 is to be set longer than the length of the coupling arm 16 of the suspension device 1A.

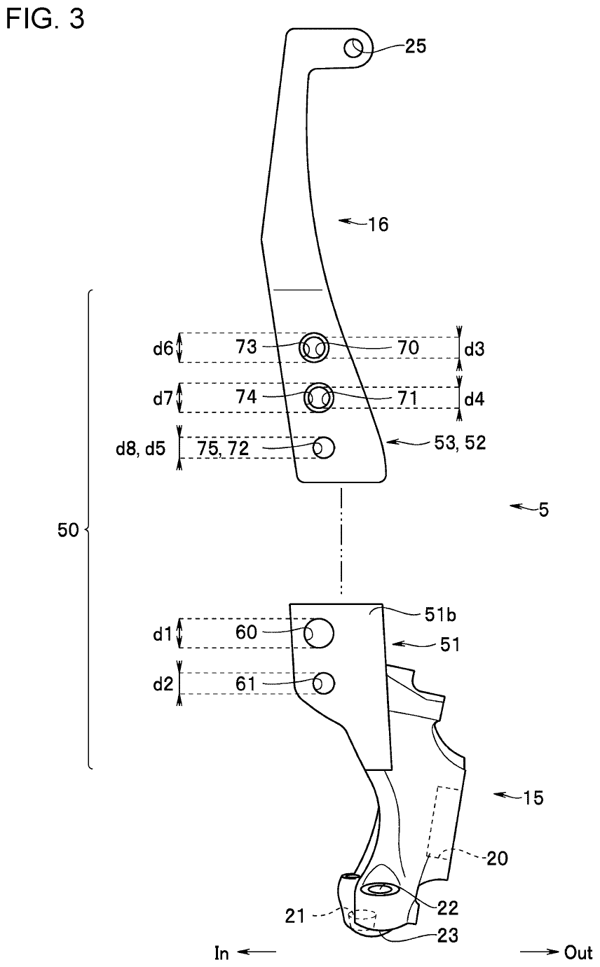

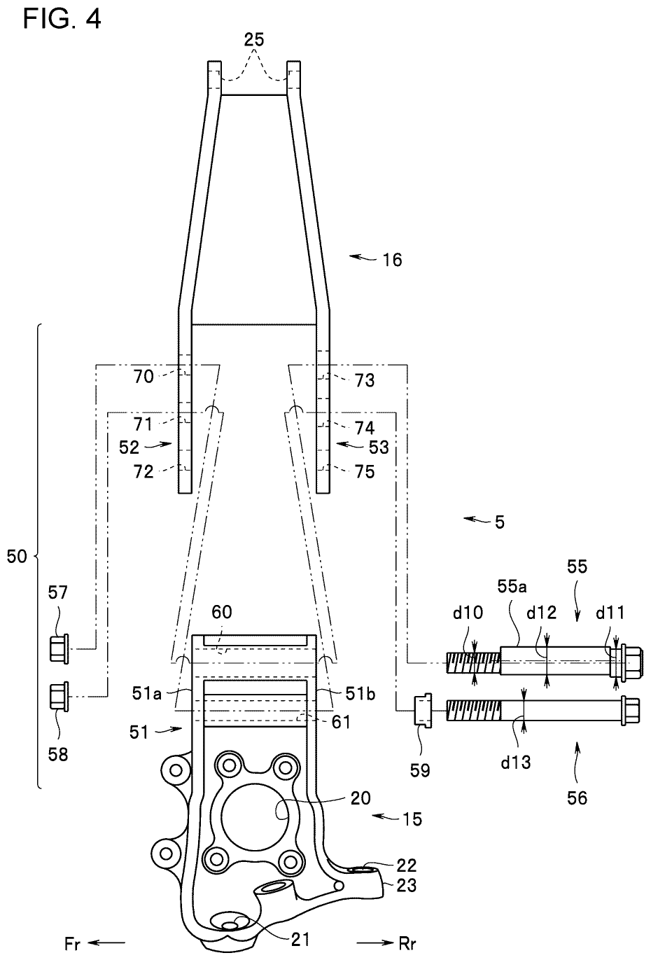

To achieve commonality of the housings 5 for such vehicles different in specification, the housing main body 15 and the coupling arm 16 are constituted by separate members as illustrated in FIGS. 3 and 4. In this case, the housing main body 15 and the coupling arm 16 are made of different materials in some embodiments. For example, the housing main body 15 is constituted by a forged product using an aluminum alloy. In addition, the coupling arm 16 is constituted by, for example, a formed product using sheet metal.

Moreover, the housing 5 includes a fixation mechanism 50 configured to fix the coupling arm 16 to the housing main body 15. The fixation mechanism 50 is capable of adjusting an extension length of the coupling arm 16 in multiple different levels (for example, two levels) relative to the housing main body 15.

As illustrated in FIGS. 3 and 4, the fixation mechanism 50 includes an arm support 51 and a first bracket 52 and a second bracket 53 that are a pair of front and rear brackets. The fixation mechanism 50 is capable of fixing the coupling arm 16 to the housing main body 15 by fastening with a first bolt 55 and a second bolt 56, and a first nut 57 and a second nut 58.

Here, for example, as illustrated in FIG. 4, in the present embodiment, an outside diameter d11 of a portion of an axial part of the first bolt 55 on the proximal end side is set larger than an outside diameter d10 of a portion of the axial part of the first bolt 55 on the distal end side. Moreover, a cam 55a is provided at a middle portion of the axial part of the first bolt 55. The cam 55a has, for example, a circular columnar shape eccentric to the axial part of the first bolt 55. In addition, an outside diameter d12 of the cam 55a is set to be, for example, substantially the same as the outside diameter d11 of the portion of the axial part of the first bolt 55 on the proximal end side. An outside diameter d13 of an axial part of the second bolt 56 is set to be the same as the outside diameter d10 of the portion of the axial part of the first bolt 55 on the distal end side throughout the entire region.

The arm support 51 is provided in an upper portion of the housing main body 15. As illustrated in FIG. 4, the arm support 51 has a substantially rectangular shape in side view. Thus, the arm support 51 includes a first bracket support surface 51a and a second bracket support surface 51b in front and rear faces. The first bracket support surface 51a and the second bracket support surface 51b are disposed so as to be parallel to each other.

In addition, the arm support 51 has a first bolt insertion hole 60 and a second bolt insertion hole 61 that are a pair of upper and lower bolt insertion holes.

The first bolt insertion hole 60 and the second bolt insertion hole 61 are each a through hole extending through the arm support 51 in a front-rear direction of the vehicle body, from the first bracket support surface 51a to the second bracket support surface 51b. The first bolt insertion hole 60 and the second bolt insertion hole 61 are disposed so as to be parallel to each other.

Here, an inside diameter d1 of the first bolt insertion hole 60 is formed larger than an inside diameter d2 of the second bolt insertion hole 61. In one example, the inside diameter d1 of the first bolt insertion hole 60 is set to be substantially the same as the outside diameter d12 of the cam 55a of the first bolt 55. In addition, the inside diameter d2 of the second bolt insertion hole 61 is set to be substantially the same as the outside diameter d13 of the axial part of the second bolt 56.

The first bracket 52 is provided in a lower front portion of the coupling arm 16. The first bracket 52 has a flat plate shape capable of abutting on the first bracket support surface 51a. The first bracket 52 has a third bolt insertion hole 70, a fourth bolt insertion hole 71, and a fifth bolt insertion hole 72. The third to fifth bolt insertion holes 70 to 72 are linearly formed along an up-down direction of the first bracket 52.

Here, the center-to-center distance between the third bolt insertion hole 70 and the fourth bolt insertion hole 71 and the center-to-center distance between the fourth bolt insertion hole 71 and the fifth bolt insertion hole 72 are each set equal to the center-to-center distance between the first bolt insertion hole 60 and the second bolt insertion hole 61. In addition, inside diameters d3 to d5 of the third to fifth bolt insertion holes 70 to 72 are each set to be substantially the same as the inside diameter d2 of the second bolt insertion hole 61.

The second bracket 53 is provided in a lower rear portion of the coupling arm 16. The second bracket 53 has a flat plate shape capable of abutting on the second bracket support surface 51b. The second bracket 53 has a sixth bolt insertion hole 73, a seventh bolt insertion hole 74, and an eighth bolt insertion hole 75. The sixth to eighth bolt insertion holes 73 to 75 are linearly formed along an up-down direction of the second bracket 53.

Here, the center-to-center distance between the sixth bolt insertion hole 73 and the seventh bolt insertion hole 74 and the center-to-center distance between the seventh bolt insertion hole 74 and the eighth bolt insertion hole 75 are each set equal to the center-to-center distance between the first bolt insertion hole 60 and the second bolt insertion hole 61. In addition, the sixth to eighth bolt insertion holes 73 to 75 are disposed at positions so as to face the third to fifth bolt insertion holes 70 to 72, respectively. In addition, inside diameters d6 and d7 of the sixth bolt insertion hole 73 and the seventh bolt insertion hole 74 are each set to be substantially the same as the inside diameter d1 of the first bolt insertion hole 60. Moreover, an inside diameter d8 of the eighth bolt insertion hole 75 is set to be substantially the same as the inside diameter d2 of the second bolt insertion hole 61.

When the housing 5 is used for a vehicle set at the first vehicle height, as illustrated in FIGS. 4 to 6, the coupling arm 16 is positioned relative to the housing main body 15 so as to cause the third bolt insertion hole 70 and the sixth bolt insertion hole 73 to communicate with the first bolt insertion hole 60. The coupling arm 16 is further positioned relative to the housing main body 15 so as to cause the fourth bolt insertion hole 71 and the seventh bolt insertion hole 74 to communicate with the second bolt insertion hole 61.

The first bolt 55 is inserted into the sixth bolt insertion hole 73, the first bolt insertion hole 60, and the third bolt insertion hole 70. At this point, the cam 55a is disposed inside the first bolt insertion hole 60. The first nut 57 is then threadedly engaged with the first bolt 55.

In addition, the second bolt 56 is inserted into the seventh bolt insertion hole 74, the second bolt insertion hole 61, and the fourth bolt insertion hole 71. The second nut 58 is then threadedly engaged with the second bolt 56. At this point, an adapter 59 having a ring shape is interposed between the seventh bolt insertion hole 74 and the second bolt 56. The adapter 59 has an outside diameter substantially the same as the inside diameter d7 of the seventh bolt insertion hole 74 and has an inside diameter substantially the same as the outside diameter d13 of the second bolt 56. Thus, rattling between the second bolt 56 and the second bracket 53 can be eliminated.

The coupling arm 16 is firmly fixed to the housing main body 15 by fastening by threaded engagement between the first bolt 55 and the first nut 57 and threaded engagement between the second bolt 56 and the second nut 58.

By fixing the coupling arm 16 as described above, the length of the coupling arm 16 extending from the housing main body 15 is set to a first length.

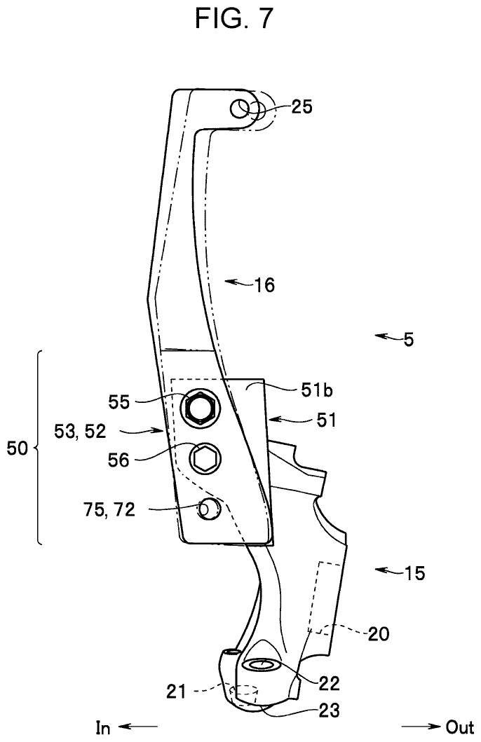

Here, for example, as illustrated in FIG. 7, the inclination angle of the coupling arm 16 to the housing main body 15 can be changed with the cam 55a. That is, the first bolt 55 is rotated relative to the first and second brackets 52 and 53, and the eccentric position of the cam 55a to the first and second brackets 52 and 53 is thereby changed. The inclination angle of the coupling arm 16 to the housing main body 15 is changed according to such a change in the eccentric position of the cam 55a.

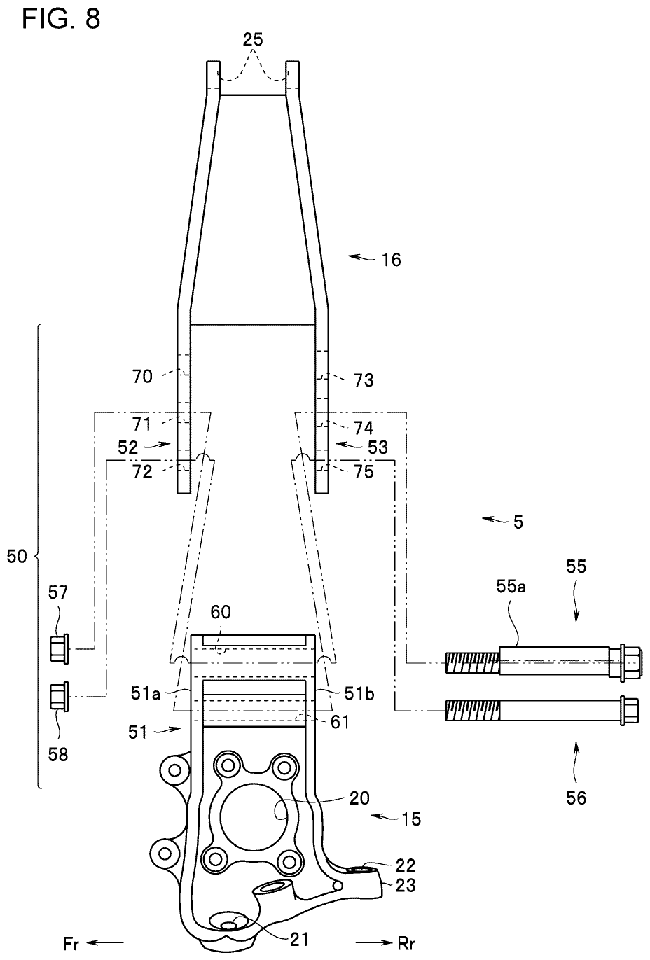

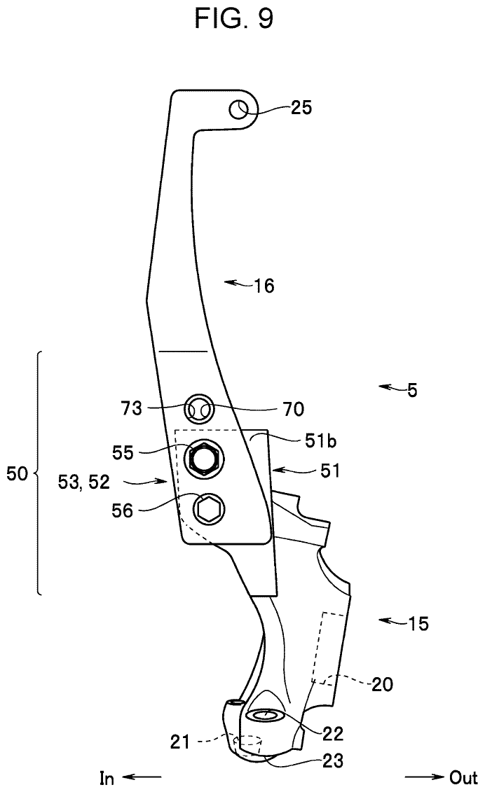

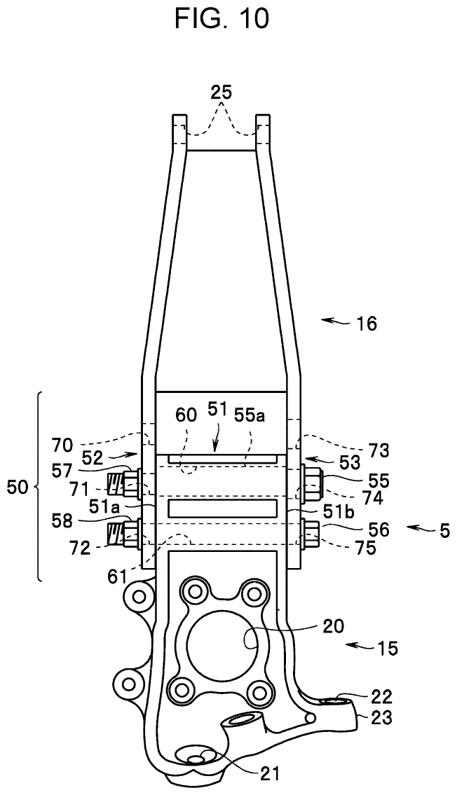

In addition, when the housing 5 is used for a vehicle set at the second vehicle height greater than the first vehicle height, as illustrated in FIGS. 8 to 10, the coupling arm 16 is positioned relative to the housing main body 15 so as to cause the fourth bolt insertion hole 71 and the seventh bolt insertion hole 74 to communicate with the first bolt insertion hole 60. The coupling arm 16 is further positioned relative to the housing main body 15 so as to cause the fifth bolt insertion hole 72 and the eighth bolt insertion hole 75 to communicate with the second bolt insertion hole 61.

The first bolt 55 is inserted into the seventh bolt insertion hole 74, the first bolt insertion hole 60, and the fourth bolt insertion hole 71. At this point, the cam 55a is disposed inside the first bolt insertion hole 60. The first nut 57 is then threadedly engaged with the first bolt 55.

In addition, the second bolt 56 is inserted into the eighth bolt insertion hole 75, the second bolt insertion hole 61, and the fifth bolt insertion hole 72. The second nut 58 is then threadedly engaged with the second bolt 56.

The coupling arm 16 is firmly fixed to the housing main body 15 by fastening by threaded engagement between the first bolt 55 and the first nut 57 and threaded engagement between the second bolt 56 and the second nut 58.

By fixing the coupling arm 16 as described above, the length of the coupling arm 16 extending from the housing main body 15 is set to a second length greater than the first length.

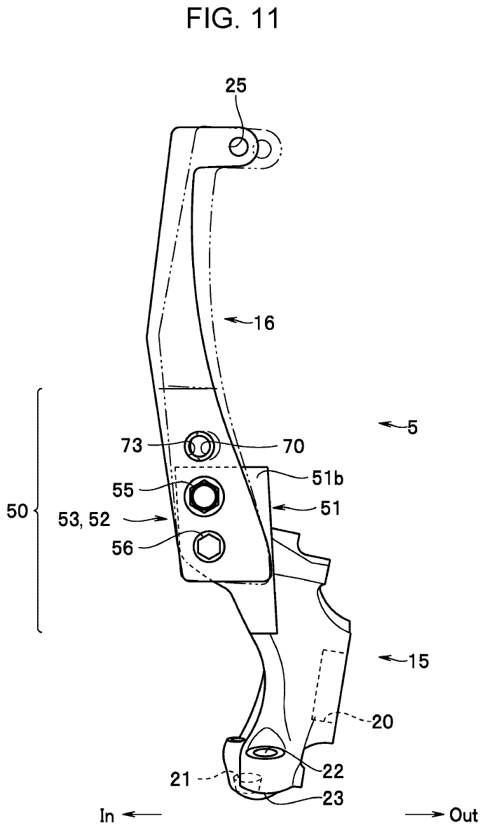

Here, for example, as illustrated in FIG. 11, the inclination angle of the coupling arm 16 to the housing main body 15 can be changed with the cam 55a. That is, the first bolt 55 is rotated relative to the first and second brackets 52 and 53, and the eccentric position of the cam 55a to the first and second brackets 52 and 53 is thereby changed. The inclination angle of the coupling arm 16 to the housing main body 15 is changed according to such a change in the eccentric position of the cam 55a.

According to such an embodiment, the housing 5 used for a high-mount double-wishbone suspension device includes the housing main body 15 configured to support the drive shaft 37, the coupling arm 16 constituted by a separate member from the housing main body 15 and having the distal end portion to which the upper arm 8 is coupled, and the fixation mechanism 50 configured to fix the coupling arm 16 to the housing main body 15. The fixation mechanism 50 is capable of fixing the coupling arm 16 to the housing main body 15 in multiple fixation positions with different lengths from the housing main body 15 to the distal end portion of the coupling arm 16. Thus, high versatility can be ensured for vehicle specifications.

That is, the fixation mechanism 50 is capable of fixing the coupling arm 16 to the housing main body 15 in multiple different fixation positions. Thus, without changing, for example, the shapes of the housing main body 15 and the coupling arm 16, the length of the coupling arm 16 extending from the housing main body 15 can be changed according to the vehicle height used for a vehicle of each specification.

In this case, the fixation mechanism 50 of the present embodiment employs a configuration in which the coupling arm 16 can be fixed to the housing main body 15 in multiple fixation positions with bolts and nuts. Thus, the coupling arm 16 can be firmly fixed to the housing main body 15.

In addition, in the housing 5 of the present embodiment, the housing main body 15 is constituted by an aluminum forged product, and the coupling arm 16 is constituted by a sheet metal processed product. Thus, weight reduction of the housing main body 15 and ensuring the strength of the coupling arm 16 can be made mutually compatible.

In addition, the housing 5 of the present embodiment includes the cam 55a capable of adjusting the inclination of the housing main body 15 to the coupling arm 16. Thus, a camber of a vehicle can be adjusted.

The disclosure described in the embodiment above is not limited to the embodiment, and, in addition, various modifications can be made in the implementation stage without departing from the spirit and scope of the disclosure. For example, the number of the bolt insertion holes provided in each of the first bracket 52 and the second bracket 53 can alternatively be four or more. In addition, the fixation mechanism 50 may also have a configuration in which the arm support 51 has three or more bolt insertion holes, and the first bracket 52 and the second bracket 53 each have two bolt insertion holes. Moreover, the fixation mechanism 50 can alternatively employ a configuration in which the arm support 51, the first bracket 52, and the second bracket 53 each have three or more bolt insertion holes. In this case, by causing at least two bolt insertion holes of the arm support 51 to communicate with at least two bolt insertion holes of the first bracket 52 and at least two bolt insertion holes of the second bracket 53, the coupling arm 16 can be fastened to the housing main body 15 with at least two bolts and at least two nuts.

Further, the above-described embodiment includes the disclosures at various stages, and various disclosures can be extracted by appropriately combining constituent elements disclosed herein.

A double-wishbone suspension device has a basic structure in which an upper arm and a lower arm are coupled to a housing (knuckle) configured to support an axle of a vehicle. Moreover, in a high-mount double-wishbone suspension device, an upper arm is coupled to a housing at a position above a wheel (for example, refer to Japanese Unexamined Patent Application Publication No. 2004-291963). Thus, a housing used for such a high-mount double-wishbone suspension device includes a long arm extending from a housing main body to a point above a tire.

In a high-mount double-wishbone suspension device, the length of an arm extending from a housing main body is to be changed according to a specification of a vehicle. For example, an arm of a housing used for a sport-utility vehicle (SUV) with high vehicle height is set longer than an arm of a housing used for a vehicle with standard vehicle height. Thus, even for housings used for the same vehicle model, various housings are to be developed according to vehicle specifications.

It is desirable to provide a housing that can ensure high versatility for vehicle specifications.

An aspect of the disclosure provides a housing for a high-mount double-wishbone suspension device. The housing includes a housing main body, a coupling arm, and a fixation mechanism. The housing main body is configured to support an axle of a vehicle. The coupling arm is constituted by a separate member from the housing main body and has a distal end portion to which an upper arm is coupled. The fixation mechanism is configured to fix the coupling arm to the housing. The fixation mechanism is configured to fix the coupling arm to the housing main body in multiple fixation positions with different lengths from the housing main body to the distal end portion of the coupling arm.

Obviously, numerous modifications and variations of the present invention are possible in light of the above teachings. It is therefore to be understood that within the scope of the appended claims, the invention may be practiced otherwise than as specifically described herein.

1. A housing for a high-mount double-wishbone suspension device, comprising:
a housing main body configured to support an axle of a vehicle;
a coupling arm having a distal end portion to which an upper arm is coupled; and
a fixation mechanism that fixes the coupling arm to the housing,
wherein the fixation mechanism fixes the coupling arm to the housing main body in a plurality of fixation positions with different lengths from the housing main body to the distal end portion of the coupling arm.

2. The housing according to claim 1, wherein the fixation mechanism fixes the coupling arm to the housing main body at a plurality of fastening places.

3. The housing according to claim 1, wherein the housing main body is an aluminum forged product, and the coupling arm is a sheet metal processed product.

4. The housing according to claim 1, wherein the fixation mechanism comprises a cam configured to adjust an inclination of the housing main body to the coupling arm.

5. The housing according to claim 2, wherein the housing main body is an aluminum forged product, and the coupling arm is a sheet metal processed product.

6. The housing according to claim 2, wherein the fixation mechanism comprises a cam configured to adjust an inclination of the housing main body to the coupling arm.

7. The housing according to claim 3, wherein the fixation mechanism comprises a cam configured to adjust an inclination of the housing main body to the coupling arm.

8. The housing according to claim 5, wherein the fixation mechanism comprises a cam configured to adjust an inclination of the housing main body to the coupling arm.
